(19) United States
(12) Patent Application Publication
(10) Pub. No.: US 2014/0042352 A1
(43) Pub. Date: Feb. 13, 2014

(54) SOLENOID VALVE FOR A PRESSURE CONTAINER

(71) Applicant: Andreas Zieger, Hofstatten an der Raab (AT)

(72) Inventor: Andreas Zieger, Hofstatten an der Raab (AT)

(73) Assignee: MAGNA STEYR Fahrzeugtechnik AG & CO. KG, Graz (AT)

(21) Appl. No.: 13/809,141

(22) PCT Filed: Jul. 4, 2011
(86) PCT No.: PCT/EP2011/003307

§ 371 Date: Mar. 29, 2013

(30) Foreign Application Priority Data
Jul. 8, 2010 (DE) 10 2010 026 549.7

(51) Int. Cl. F16K 31/06

(52) U.S. Cl. CPC F16K 31/06
USPC 251/129.15

(57) ABSTRACT

A solenoid valve for a pressure container, that includes a valve housing and a valve base member having a first opening for directing the fluid into and/or out of a pressure container and a second opening for directing the fluid into or out of the valve. The valve is constructed in such a manner that only a small application of force has to be provided in order to move a sealing element from its seat and to release a direct connection between a first opening for directing the fluid into and out of the pressure container and a second opening for directing the fluid into and out of the valve. The fluid is directed through the first opening into a space which extends between a tappet and the sealing element, whereby a pressure is built up in the space and a first positioning path travels by the tappet when an magnetic coil is activated so that the through-hole of the sealing element is released and the sealing element retains its position.

The present application is a National Stage application of PCT International Application No. PCT/EP2011/003307 (filed on Jul. 4, 2011), under 35 U.S.C. §371, which claims priority to German Patent Application No. DE 10 2010 026 549.7 (filed on Jul. 8, 2010), which are each hereby incorporated by reference in their complete respective entireties.

### FIELD OF THE INVENTION

The present invention relates to a solenoid valve for a pressure container and a method for operating a solenoid valve in a pressure container and a pressure container, in particular a composite container.

### BACKGROUND OF THE INVENTION

A pressure container for storing liquid or gaseous media, preferably hydrogen or natural gas, comprises at least one storage container for surrounding the liquid or gaseous medium having at least one opening into which a valve is inserted. The liquid or gaseous medium is introduced and removed by means of the switching and control elements which are incorporated in the valve base member. When the medium is removed, electrical power is applied to the solenoid valve and it is actively opened. During filling, no electrical power is applied to the solenoid valve. For safety reasons, the solenoid valve is closed in the current-free state.

A pilot-actuated valve is generally used as a solenoid valve in such pressure containers in order to keep the power consumption low. An example of such a pilot-actuated valve for a pressure container is EP 1 681 507 A1. The pilot-actuated solenoid valve has a tappet having a carrier, with play for free movement of the tappet being provided between the carrier and tappet. Owing to the actuation of the sealing element responsible for the pilot flow, the pressure forces acting on the sealing element of the main flow are changed in such a manner that the main seat is opened or closed.

WO 2009/006684 A1 sets out a valve which enables a medium to flow between an inlet and an outlet when a magnetic coil is activated. When the magnetic coil is activated, a tappet moves in a direction which is counter to the sealing element. As a result, the medium flows from a control space, which is formed between the tappet and sealing element and which has a higher pressure, to the outlet which has a lower pressure. The sealing element has a through-hole through which the medium flows from the control space to the outlet. When the pressure at the outlet side has become similar to that in the control space, the sealing element moves from its support and allows a direct flow connection for the medium between the inlet and the outlet.

### SUMMARY OF THE INVENTION

An object of the present invention is to provide a solenoid valve for a pressure container, a method for operating a solenoid valve in a pressure container and a pressure container in which only a small application of force must be provided in order to move the sealing element from its seat and to release a direct connection between a first opening to direct the fluid into and out of the pressure container and a second opening to direct the fluid into and out of the valve. Furthermore, the solenoid valve is intended to be cost-effective in terms of production.

This object is achieved by a solenoid valve for a pressure container, comprising a valve housing and a valve base member having a first opening for directing a fluid into and/or out of a pressure container and a second opening for directing the fluid into or out of the valve, a magnetic coil, a sealing element which has a through-hole, a resilient element, a movable tappet, to which a pressure force can be applied by the resilient element when the magnetic coil is deactivated so that the tappet closes the through-hole of the sealing element and which can be moved when the magnetic coil is activated, the tappet having space for free movement, a carrier which is connected to the tappet for moving the sealing element, the fluid being able to be directed through the first opening into a space which extends between the tappet and sealing element, whereby a pressure can be built up in the space and a first positioning path being able to be traveled by the tappet by activating the magnetic coil so that the through-hole of the sealing element is released and the sealing element retains its position. This has the advantage of a simplified valve structure. The carrier is preferably mechanically connected to the sealing element.

In another embodiment, when the through-hole of the sealing element is released by the tappet, a counter pressure can be built up at the second opening owing to the fluid flowing through the first opening and the through-hole, the tappet (after an adequate pressure relationship has been reached between the second opening and the first opening or between the second side and the first side of the sealing element) traveling, when the magnetic force of the magnetic coil is activated, a second positioning path in which the sealing element can be moved by the carrier from its position and releases the second opening, whereby a fluid-directing connection which is preferably greater than the through-hole can be released between the first opening and the second opening. Owing to such a stepped opening of the valve, the force which is required to move the sealing element from its position and to release the second opening is reduced. This occurs in particular in that a counter-pressure is built up at a second side of the sealing element which supports the movement of the sealing element from a position when a second opening is closed. In addition, the time required to release the second opening is shortened since the sealing element can be actively moved by the carrier.

In an additional variant, the carrier has a first recess which is directed towards the sealing element and the sealing element comprises a second recess, a carrier element being positioned so as to engage in the first recess and the second recess and a geometry of the first recess and the second recess being constructed in such a manner that the tappet travels the first positioning path without the sealing element changing its position. Owing to this structural configuration, the present invention requires only a single sealing element. Costs for the production of the valve are thereby reduced.

Advantageously, an axial extent of the second recess of the sealing element is greater than the axial extent of the first recess of the carrier and/or the second recess of the sealing element is opposite the first recess of the carrier and/or the first recess and the second recess are constructed so as to be open with respect to each other.

In an additional embodiment, the carrier element is secured in the first recess of the carrier in a positive and/or non-positive-locking manner. Consequently, the carrier element is securely connected to the carrier and follows the movement of the tappet.

In an additional embodiment, the carrier surrounds the sealing element, the first recess of the carrier and/or the second recess of the sealing element being constructed as an annular groove and the carrier element substantially being in the form of a ring.

Preferably, when a through-hole of the sealing element is closed by the tappet, the sealing element preferably rests on the valve base member in order to close the second opening. Consequently, the main seat of the valve is produced in a reliable manner.

In an additional variant, the sealing element has, at the side thereof adjacent to the tappet, a substantially centrally arranged projection which surrounds the through-hole and on which the tappet rests when the magnetic coil is deactivated, the space between the tappet and sealing element being constructed as an annular space. Owing to the construction of the projection, there is a particularly high level of fitting precision when the tappet is positioned and consequently a reliable closure of the through-hole.

In an additional embodiment, the space is connected to the first opening by means of a fluid-directing channel and/or the space extends between the valve housing and the tappet and/or the carrier. If the fluid flows out of the first opening into the annular space or space between the tappet and sealing element, the pressure brings about a force which presses the sealing element onto the valve base member so that the second opening is closed by the sealing element.

In another variant, the carrier and the tappet are constructed integrally and/or a method described in this patent application can be carried out by the valve.

In a preferred embodiment, the sealing element comprises at least partially, in particular completely, a metal material or plastics material. Additional inserts on the main seat and auxiliary seat are thereby dispensed with in the case of production from plastics material, whereby the valve structure can be constructed in a particularly cost-effective manner. In addition, a coating of the friction faces which would otherwise be necessary between the sealing element and carrier is consequently dispensed with since the friction pairing between the sealing element of plastics material and the carrier of metal has constantly good friction properties and consequently is also reliable without a coating.

In another embodiment, the tappet and/or the valve housing and/or the carrier and/or the valve base member at least partially, in particular completely, comprise(s) metal, for example, steel or aluminum.

A pressure container in accordance with the invention, in particular a composite container, comprises a valve described in the patent application.

A method in accordance with the invention for operating a solenoid valve in a pressure container comprises the steps of: applying electric current to a magnetic coil, moving a tappet away from a sealing element owing to the magnetic force, causing a fluid to flow from the pressure container through a through-hole, wherein, after adjusting a pressure relationship between a first side and a second side of the sealing element, an opening is released for discharging the fluid from the pressure container and the valve, wherein, after the fluid has flowed from the pressure container into a space between the tappet and sealing element, a first pressure is built up and, when the magnetic coil is activated, the tappet travels a first positioning path in the direction away from the sealing element, whereby a carrier is moved and the through-hole of the sealing element is released by the tappet without the sealing element moving since the force effective owing to the pressure in the space between the tappet and sealing element is at first still greater than the force effective owing to the pressure in the second opening. The tappet consequently has an integrated sealing face and presses, owing to the effective resilient force, the sealing element with the through-hole onto the main seat against the valve base member and closes the second opening as long as no electric current is applied to the magnetic coil.

In another embodiment, after the through-hole has been released, the fluid flows through the through-hole and a counter-pressure is built up at the second side of the sealing element with respect to the pressure existing at the first side of the sealing element so that the sealing element can be moved with a small force. The opening and closing times of the valve are thereby reduced.

In another variant, the magnetic coil is or remains activated after the first positioning path of the tappet and the tappet travels a second positioning path, the sealing element being carried by the tappet and/or the carrier and the opening of the main seat for discharging the fluid from the valve being released as soon as the force of the magnetic coil and the pressure relationship between both sides of the sealing element is sufficient for this purpose. Before and/or during the second positioning path, the magnetic force may be greater than or the same as before and/or during the first positioning path.

Preferably, when the pressure container is filled via the solenoid valve with the magnetic coil switched into the current-free, deactivated state, the sealing element and the tappet are moved counter to a resilient force by the pressure of the incoming medium and the opening of the valve base member is opened.

### BRIEF DESCRIPTION OF THE DRAWINGS

An embodiment of the invention is described in greater detail below with reference to the appended drawings, in which:

FIG. 1 illustrates a cross section through a solenoid valve.

FIG. 2 illustrates a cutout of the solenoid valve of FIG. 1.

### DETAILED DESCRIPTION OF EMBODIMENTS

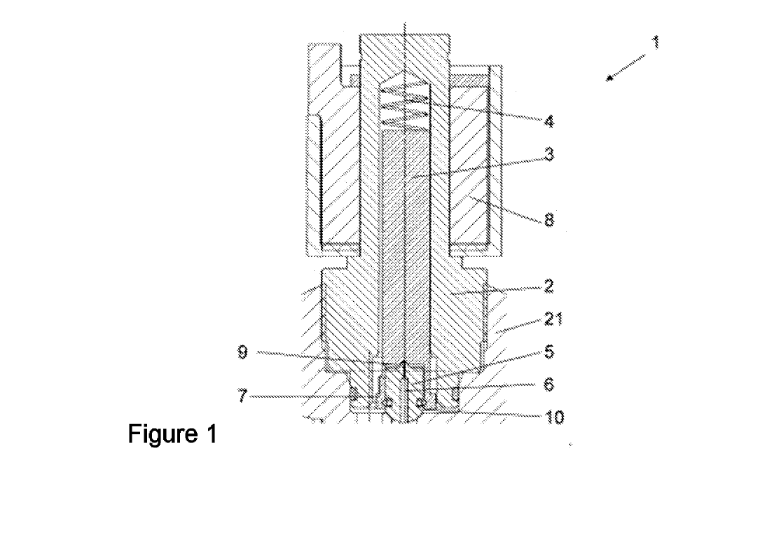

The solenoid valve 1 illustrated in FIG. 1 serves to remove a liquid or a gas, for example, hydrogen or natural gas, which is referred to as fluid below, from a pressure container or to fill the pressure container (not illustrated).

The solenoid valve 1 comprises a valve housing 2, in the interior of which there is arranged a tappet 3 which is pressed by means of a resilient element 4 against a sealing element 5. The sealing element 5 in this instance has a through-hole 6 in the form of a continuous opening which has two different cross sections. In the direction towards the tappet 3, the through-hole 6 has a smaller diameter, which is adjoined by a larger diameter which extends in the opposing direction. A magnetic coil 8 engages around the valve housing 2 and consequently also the tappet 3 which is arranged in the valve housing 2. The tappet 3 rests with the end face thereof on a projection 15 of the sealing element 5. The sealing element 5 itself rests on a valve base member 21 at a second opening 12 and consequently closes the valve 1 with respect to the environment. This portion of the sealing element 5 is referred to as the main seat 10. In contrast, the portion which the tappet 3 takes up on the projection 15 of the sealing element 5, in which the through-hole 6 of the sealing element 5 is held closed, is referred to as the pilot seat 9. The valve 1 is secured to the pressure container by means of the valve base member 21.

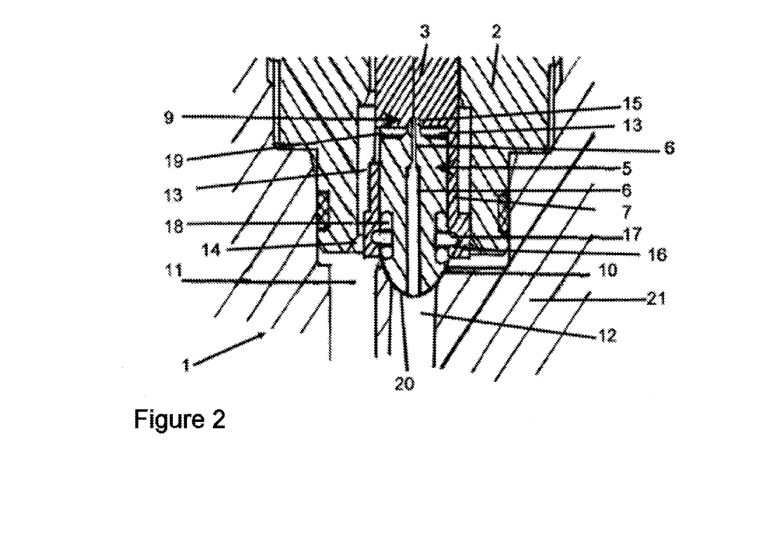

In the pilot seat 9, there is formed between the tappet 3 and the sealing element 5 an annular apace 13 (FIG. 2) which is connected to the opening 11 by means of a channel 14, the opening 11 leading to a pressure container. Furthermore, the tappet 3 is constructed integrally with a carrier 7, the carrier 7 substantially surrounding the sealing element 5. The sealing element 5 has a first annular groove 18 which is constructed in the lower portion of the sealing element 5 in the direction towards the opening 12.

A carrier element 17 is placed in this annular groove 18. This carrier element 17 is constructed in such a manner that it protrudes in terms of its dimensions radially over the sealing element 5 and engages in a second annular groove 16 of the carrier 7. This second annular groove 16 is constructed in such a manner that the thickness of the carrier element 17 corresponds to the axial extent of the annular groove 16 so that the carrier element 17 cannot move inside the recess 16 of the carrier 7. In contrast, the axial extent of the first annular groove 18 of the sealing element 5 exceeds the thickness of the carrier element 17 so that the carrier element 17 is arranged with spacing from the inner walls of the annular groove 18 of the sealing element 5.

The operating method of the solenoid valve 1 is now intended to be explained in greater detail below. Starting from the position of the valve 1 illustrated in FIG. 2, the carrier element 17 is arranged centrally in the annular groove 18 of the sealing element 5. The case is intended to be considered in which the fluid is intended to be removed from the pressure container, which is not illustrated in greater detail, and flows out of the valve 1 through the opening 12.

In this instance, the fluid first flows through the opening 11 via the channel 14 into the annular space 13. Before the magnetic coil 8 is activated, in the annular space 13 or space 13 owing to the fluid-directing connection provided between the first opening 11 and the annular space 13 in the annular space 13, there is substantially the same pressure as at the first opening 11, which opens into a pressure container inner space which is enclosed by the pressure container. Owing to this pressure, there is applied to a first side 19 of the sealing element 5 a force which presses the sealing element 5 onto the valve base member 21 so that the second opening 12 is closed. The second opening 12 opens when the pressure container having the valve 1 is used in a vehicle, for example, for an internal-combustion engine or a fuel cell and a filling connection.

If the magnetic coil 8 is activated, the tappet 3 moves away from the projection 15 of the sealing element 5 in a first positioning path and consequently releases the through-hole 6. In the first positioning path which the tappet 3 travels, the carrier element 17 which is carried by the carrier 7 owing to the movement of the tappet 3, still moves within the second recess 18 of the sealing element 5. The sealing element 5 consequently remains in its position. The fluid flows out of the annular space 13 through the through-hole 6 released by the tappet 3 and at the opposite side out of the sealing element 5. This means that a counter-pressure builds up at that second side 20 of the sealing element 5 and presses from the outer side against the sealing element 5 so that the sealing element 5 can be moved away from the second opening 12 with a small force.

When the magnetic coil 8 is further activated and there is sufficient pressure compensation between the annular space 13 and the second opening 12, the tappet 3 travels a second positioning path in which the carrier element 17 is now pressed by the carrier 7 against the wall of the annular groove 18 of the sealing element 5, the sealing element 5 being pressed out of its position. Owing to the counterpressure which has been adjusted at the second side 20 of the sealing element 5, only a smaller force is required to move the sealing element 5 from its position and the opening 12 of the valve base member 21 is released. Owing to this movement of the sealing element 5, the opening 11 is directly connected to the opening 12, the fluid being able to flow out of the pressure container in a greater quantity than through the through-hole 6.

When the removal operation has ended, the magnetic coil 8 is switched into a current-free state. Since the opening 11 at this time is directly connected to the opening 12, there is substantially the same pressure both in the annular space 13 and in the opening 12. The pressure forces thereby have only a small influence on the position of the sealing element 5. Consequently, when the coil is switched into a current-free state, the sealing element 5 is moved against the opening 12 of the valve housing 21 by the force of the resilient element 4, whereby the opening 12 is closed.

If the pressure container is now intended to be filled, the magnetic coil 8 is switched into a current-free state. Owing to the magnetic coil 8 being switched into the current-free, deactivated state, the tappet 3 is pressed by the effective resilient force of the resilient element 4 onto the sealing element 5 and consequently closes the valve 1. Owing to the pressure of the incoming fluid, which produces a force at the second side 20 of the sealing element 5, the sealing element 5 and the tappet 3 are pressed counter to the force of the resilient element 4 and the opening 12 of the valve base member 21 is released.

Under general consideration, significant advantages are connected to the solenoid valve 1 in accordance with the invention. The structural configuration of the valve 1 reduces the force which is required in order to move the sealing element 5 from its position when fluid is intended to be removed from the pressure container. In particular when fluid is removed from the pressure container, the time required to open the valve 1 is reduced since, in the case of adequate pressure compensation between the two sides 19 and 21 of the sealing element 5, the sealing element 5 can be directly opened by the carrier 7 and by the carrier element 17. The integration of the carrier element 17 in the two annular grooves 16 and 18 has been found to be particularly advantageous since the sealing element 5 during assembly is pushed only into the carrier 7 in which the carrier element 17 is already positioned. In addition, owing to the configuration of the sealing element 5 of plastics material, additional inserts in the main seat 10 and pilot seat 9 are dispensed with, whereby the construction of the valve 1 becomes more reliable and more cost-effective. In addition, the friction pairing between the sealing element 5 of plastics material and the metal carrier 7 has been found to be particularly advantageous since it is possible to dispense with a coating of the relevant surfaces of both components which would otherwise be required.

### LIST OF REFERENCE NUMERALS

1 Valve
2 Valve housing
3 Tappet
4 Resilient element
5 Sealing element
6 Through-hole
7 Carrier
8 Magnetic coil
9 Pilot seat
10 Main seat
11 First opening
12 Second opening
13 Annular space
14 Channel
15 Projection
16 Second annular groove
17 Carrier element
18 First annular groove
19 First side of the sealing element
Second side of the sealing element
21 Valve base member

1.-16. (canceled)

17. A valve for a pressure container, comprising:
a valve housing and a valve base member having a first opening for directing a fluid into and/or out of a pressure container and a second opening for directing the fluid into or out of the valve;
a magnetic coil;
a sealing element which has a through-hole;
a resilient element;
a movable tappet the tappet having space for free movement and configured to receive a pressure force from the resilient element when the magnetic coil is deactivated so that the tappet closes the through-hole of the sealing element and move when the magnetic coil is activated; and
a carrier which is connected to the tappet and configured to move the sealing element,
wherein the fluid is directed through the first opening into a space which extends between the tappet and sealing element, such that a pressure is built up in the space and a first positioning path is traveled by the tappet by activating the magnetic coil so that the through-hole of the sealing element is released and the sealing element retains its position.

18. The valve of claim 17, wherein:
when the through-hole of the sealing element is released by the tappet, a counter-pressure is built up at the second opening due to the fluid flowing through the first opening and the through-hole;
the tappet is moved when the magnetic force of the magnetic coil is activated; and
a second positioning path in which the sealing element is moved by the carrier from its position and releases the second opening, such that a fluid-directing connection which is greater than the through-hole is released between the first opening and the second opening.

19. The valve of claim 17, wherein:
the carrier has a first recess which is directed towards the sealing element;
the sealing element comprises a second recess;
a carrier element is provided and configured to engage in the first recess and the second recess; and
the first recess and the second recess are configured to permit travel of the tappet along the first positioning path without the sealing element changing its position.

20. The valve of claim 19, wherein:
an axial extent of the second recess of the sealing element is greater than the axial extent of the first recess of the carrier; and/or
the second recess of the sealing element is opposite the first recess of the carrier; and/or
the first recess and the second recess are configured to be open with respect to each other.

21. The valve of claim 19, wherein the carrier element is secured in the first recess of the carrier in a positive and/or non-positive-locking manner.

22. The valve of claim 19, wherein:
the carrier is configured to surround the sealing element;
the first recess of the carrier and/or the second recess of the sealing element are configured as an annular groove and the carrier element is configured in the form of a ring.

23. The valve of claim 17, wherein, when a through-hole of the sealing element is closed by the tappet, the sealing element rests on the valve base member in order to close the second opening.

24. The valve of claim 17, wherein:
the sealing element has, at the side thereof adjacent to the tappet, a substantially centrally arranged projection which is configured to surround the through-hole and on which the tappet rests when the magnetic coil is deactivated; and
the space between the tappet and sealing element is configured as an annular space.

25. The valve of claim 17, wherein:
the space is configured for connection to the first opening via a fluid-directing channel; and/or
the space extends between the valve housing and the tappet and/or the carrier.

26. The valve of claim 17, wherein:
the carrier and the tappet are constructed integrally; and/or
to receive an electric current at the magnetic coil;
the tappet is configured for movement away from the sealing element due to the magnetic force;
the fluid flows from the pressure container through the through-hole of the sealing element, such that, after adjusting a pressure relationship between a first side and a second side of the sealing element, the opening is released for discharging the fluid from the pressure container and the valve; and
after the fluid flows from the pressure container into the space between the tappet and sealing element, a first pressure is built up and, when the magnetic coil is activated, the tappet travels the first positioning path in the direction away from the sealing element, such that the carrier is moved and the through-hole of the sealing element is released by the tappet without the sealing element moving.

27. The valve of claim 17, wherein the sealing element comprises a metal material.

28. The valve of claim 17, wherein the sealing element comprises a plastics material.

29. A pressure container comprising:
a valve having:
a valve housing and a valve base member having a first opening for directing a fluid into and/or out of a pressure container and a second opening for directing the fluid into or out of the valve;
a magnetic coil;
a sealing element which has a through-hole;
a resilient element;
a movable tappet the tappet having space for free movement and configured to receive a pressure force from the resilient element when the magnetic coil is deactivated so that the tappet closes the through-hole of the sealing element and move when the magnetic coil is activated; and
a carrier which is connected to the tappet and configured to move the sealing element,
wherein the fluid is directed through the first opening into a space which extends between the tappet and sealing element, such that a pressure is built up in the space and a first positioning path is traveled by the tappet by activating the magnetic coil so that the through-hole of the sealing element is released and the sealing element retains its position.

30. A method for operating a valve in a pressure container, the method comprising:
applying an electric current to a magnetic coil of the valve;
moving a tappet of the valve away from a sealing element due to a magnetic force;
flowing a fluid from the pressure container through a through-hole of the sealing element;
adjusting a pressure relationship between a first side and a second side of the sealing element;
releasing an opening for discharging the fluid from the pressure container and the valve after adjusting the pressure relationship,
wherein, after the fluid has flowed from the pressure container into a space between the tappet and sealing element, a first pressure is built up and, when the magnetic coil is activated, the tappet travels a first positioning path in the direction away from the sealing element, whereby a carrier is moved and the through-hole of the sealing element is released by the tappet without the sealing element moving.

31. The method of claim 30, wherein, after the through-hole has been released, the fluid flows through the through-hole and a counter-pressure is built up at the second side of the sealing element with respect to the pressure existing at the first side of the sealing element so that the sealing element is moved with a small force.

32. The method of claim 30, wherein the magnetic coil is configured to remain activated after the first positioning path of the tappet and the tappet travels a second positioning path and the sealing element is carried by the tappet.

33. The method of claim 30, wherein the carrier and the opening for discharging the fluid from the valve is released as soon as the force of the magnetic coil and the pressure relationship between both sides of the sealing element reaches a sufficient threshold.

34. The method of claim 30, wherein:
the magnetic coil is configured to remain activated after the first positioning path of the tappet and the tappet travels a second positioning path and the sealing element is carried by the tappet; and/or
the carrier and the opening for discharging the fluid from the valve is released as soon as the force of the magnetic coil and the pressure relationship between both sides of the sealing element reaches a sufficient threshold

35. The method of claim 30, wherein, when the pressure container is filled via the valve when the magnetic coil is in a deactivated state, the sealing element and the tappet are moved counter to a resilient force by the pressure of the incoming fluid and the opening of the valve base member is thereby opened.
